(19) United States
(12) Patent Application Publication
(10) Pub. No.: US 2018/0034775 A1
(43) Pub. Date: Feb. 1, 2018

(54) FILTERING AND VERIFICATION HUB

(71) Applicant: Carneros Bay Capital, LLC, San Francisco, CA (US)

(72) Inventors: Mark CARLSON, Half Moon Bay, CA (US); Patrick STAN, Pacifica, CA (US)

(21) Appl. No.: 15/659,406

(22) Filed: Jul. 25, 2017

Related U.S. Application Data
(60) Provisional application No. 62/367,913, filed on Jul. 28, 2016.

(51) Int. Cl. H04L 29/06

(52) U.S. Cl. CPC H04L 63/0227; H04L 63/0428; H04L 63/0823; H04L 63/20; H04L 63/08; H04L 63/166; G06Q 10/107

(57) ABSTRACT

In some embodiments, a universal filtering and verification hub server is accessible over the Internet from a sponsor computer. A filtering module automatically determines a level of identity verification depending on the sponsor and the type of arrangement desired to be sponsored. An identity module and/or compliance module is activated depending on the sponsor and an automated workflow is executed. Upon completion, an arrangement program ID is generated, and is correlated with a sponsor ID. The communications are encrypted, and a high level of encryption is used for storing an arrangement program ID.

### CROSS-REFERENCES TO RELATED APPLICATIONS

This application claims the benefit of U.S. Provisional Patent Application No. 62/367,913 filed Jul. 28, 2016, entitled “Account Hub”, the disclosure of which is hereby incorporated herein by reference in its entirety.

### BACKGROUND OF THE INVENTION

The present invention relates to computer systems and methods for supporting secure computer program and file set-up and management.

### BRIEF SUMMARY OF THE INVENTION

In some embodiments, a universal filtering and verification hub server is accessible over the Internet from a sponsor computer. A filtering module automatically determines a level of identity verification depending on the sponsor and the type of arrangement desired to be sponsored. An identity module and/or compliance module is activated depending on the sponsor and an automated workflow is executed. Upon completion, an arrangement program ID is generated, and is correlated with a sponsor ID.

In some embodiments, the arrangement is for the secure storage of data. The data can be confidential or sensitive documents, proprietary software or data, or an account. In addition to, or instead of, the filtering module, a compliance module can be provided to automatically determine a level of regulatory compliance depending on the sponsor and the type of arrangement desired to be sponsored. The compliance module is activated depending on the sponsor and an automated workflow is executed. In one embodiment, the sponsor ID is a routing ID used to route to a sponsor system over a data interchange network. The communications are encrypted, and a high level of encryption is used for storing an arrangement program ID.

In some embodiments, users, sponsors and owners communicate over a first network with the filtering and verification hub server using a first encryption method. A second encryption method is used for back-end communication over a data interchange network between the filtering and verification module and owner, sponsor and arrangement processors.

In some embodiments, a URL corresponding to the arrangement program ID is generated and provided to the sponsor. The URL provides a link to a custom opening webpage maintained by the filtering and verification hub server or a companion server. The custom webpage collects information about the type of arrangement selected to be opened, and information about the user. A user identity/compliance module automatically performs appropriate background checking of the user depending upon the type of arrangement.

### BRIEF DESCRIPTION OF THE DRAWINGS

FIG. 1 is a diagram of an account hub server and system according to an embodiment.

FIG. 2 is a flow chart of an identity verification process according to an embodiment.

FIG. 3 is a flow chart of a sponsor program compliance workflow according to an embodiment.

FIG. 4 is a diagram of a URL placement system according to an embodiment.

FIG. 5 is a diagram of a checkout page for opening an account according to an embodiment.

FIG. 6 is a diagram of a partner portal according to an embodiment.

FIG. 7 is a diagram of a customer account portal according to an embodiment.

FIG. 8 is a diagram of an API proxy system according to an embodiment.

FIG. 9 is a diagram of a computer or server for devices of the system of FIG. 1 according to an embodiment.

### DETAILED DESCRIPTION OF THE INVENTION

### Sponsor Program Initiation

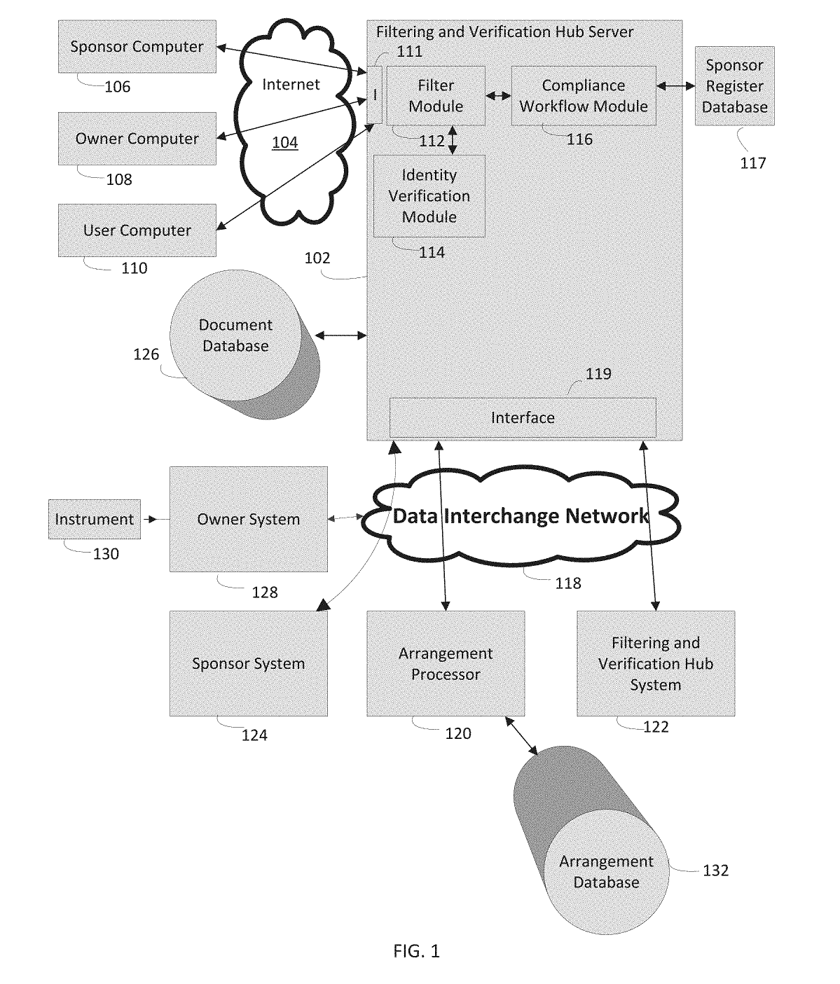

FIG. 1 is a diagram of a universal filtering and verification hub server and system according to an embodiment. A universal filtering and verification hub server 102 is accessible over the Internet 104 from a sponsor computer 106, owner computer 108 or user computer 110 through an interface 111. A filtering module 112 automatically determines a level of identity verification and regulatory compliance depending on the sponsor and the type of arrangement desired to be sponsored. An identity verification module 114 and/or compliance module 116 is activated depending on the sponsor and an automated workflow is executed pulling needed compliance documents from a document database 126. Compliance module 116 also will check to see if a sponsor is registered with a sponsor register database 117. Upon completion, an arrangement program ID is generated, and is correlated with the sponsor ID. The sponsor ID from a sponsor system 124 can be used to route through a data interchange network 118. For an owner or other user, an ID from a filtering and verification hub server 102 is used. Hub server 102 includes an interface 119 for communicating through the data interchange network 118.

In some embodiments, the filtering and verification hub is a universal account hub server is accessible over the Internet from a sponsor computer which can be a bank, an owner computer which can be a merchant computer, or user computer. Upon completion of the automated workflow, the arrangement created includes an account, and an account program ID is generated, and is correlated with the sponsor bank BIN (Bank Identification Number) or, for a merchant or other user, an account hub bank BIN is used. A BIN (Bank Identification Number) from a sponsor bank 124 can be used to route through a payment network 118. For a merchant or other user, a BIN from an account hub bank 122 is used.

In one embodiment, the filter module, or an intervening GUI (Graphical User Interface), provides a variety of options to the sponsor, which may include some or all of the following:

Type of arrangement (confidential or sensitive documents storage and access, proprietary software or data, or an account such as a gift card, General Purpose Reloadable (GPR) card, debit account, credit account, loan, etc.).

Type of sponsor (escrow agent, secure storage facility, bank, merchant, individual, charity, etc.). Address and other information identifying the sponsor.

Depending on the answers, more questions are presented. If the arrangement or account is to include a physical card, options for card design will be presented. If the sponsor has previously registered, sponsor identification information can be pulled up and displayed for confirmation, such as current address, tax ID number, etc. The identity verification can be skipped for existing registered sponsors, unless, for example, there is a change in information or the registration is too stale.

If certain instruments are selected, such as a gift card, among the further options is an allowable velocity—how many gift cards can one user obtain in a period of time? If the maximum velocity desired exceeds regulatory limits with respect to money laundering detection, the sponsor will be prompted to confirm, giving that a higher level of compliance checking will be required. If the sponsor still wants to proceed, the same compliance workflow as for a GPR card can be used.

In one embodiment, an instrument ID is tokenized for security. SSL or other encryption techniques can be used for communicating with the filtering and verification hub.

The instrument ID is only stored in an encrypted form. In one embodiment, the storage of the instrument ID at the filtering and verification hub, and at other storage points, is one of AES (128 bits and higher), TDES/TDEA (triple-length keys), RSA (2048 bits and higher), ECC (224 bits and higher), and DSA/D-H (2048/224 bits and higher). In one embodiment, end-to-end encryption is used. The encryption may be symmetric encryption using a single key to both encrypt and decrypt, or may be asymmetric encryption using a public and private key. In one embodiment, for online access, page encryption may be used. In one embodiment, hashing is used.

In one embodiment, an instrument is provided with a multi-digit code for verification in addition to the instrument ID. In one embodiment, the multi-digit code is dynamic.

### Sponsor Identity Verification Module

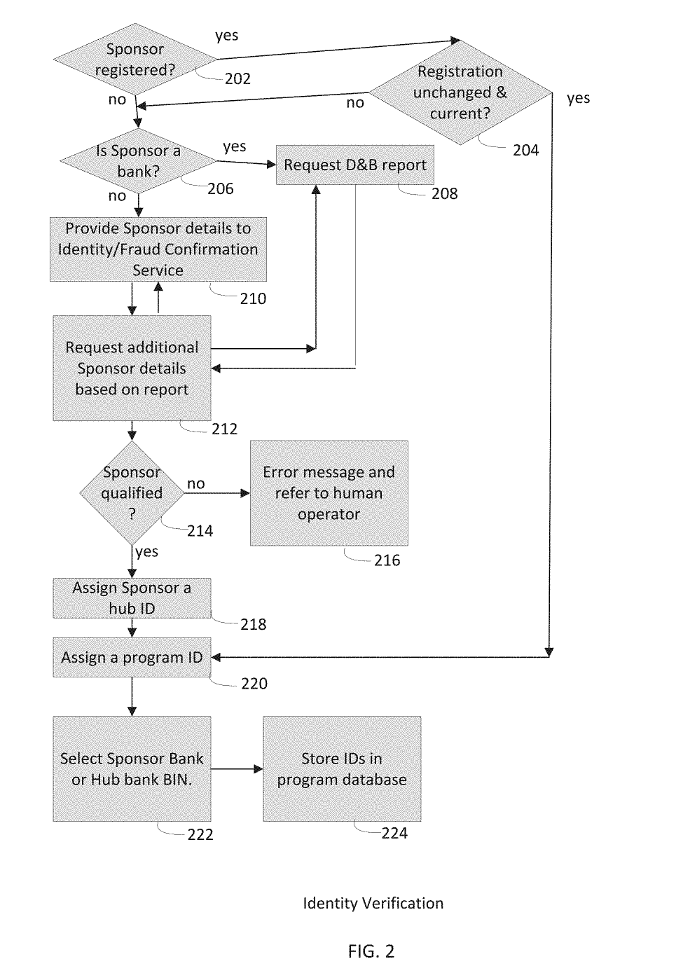

FIG. 2 shows how identity verification module 114 will automatically verify the identity of the sponsor. Upon receiving sponsor identification inputs from a GUI, a determination is made if the sponsor is already registered with the hub in step 202. If the sponsor is registered, the registration information is presented to the sponsor for any updates. If updates are made, or if the registration is stale, the verification process is continued at step 206. Otherwise, the process skips to step 220 to assign a program ID.

If the Sponsor is a bank (step 206), an abbreviated identification process for a bank is initiated, such as requesting a Dunn & Bradstreet (D&B) report (step 208). A URL for the D&B site is invoked, and the account hub registration information is auto-filled. The sponsor name is then filled in for the request. The response is examined to determine if there is more than one match. If there are additional matches, additional information is requested of the sponsor to determine which match is correct (step 212). For example, the multiple names from the multiple matches can be provided to the sponsor to select the correct match.

If the Sponsor is not a bank, such as an owner, a merchant, individual or charity, additional information is collected from the sponsor and provided to an Identity and Fraud confirmation service, such as Dunn & Bradstreet (step 210). Additional details are requested from the sponsor as needed (step 212). If the sponsor is identified satisfactorily, a sponsor hub ID is assigned (step 218). If there are still issues with verifying the sponsor, an error message is displayed and/or a human operator is contacted (step 216).

A program ID is assigned in step 220. If the sponsor is a bank, the sponsor bank can elect to use its own BIN, or use the hub bank BIN (step 222). For merchants, individuals and charities, the hub bank BIN is the default. The assigned IDs and BIN are stored in a program database (step 224) for later use when issuing accounts/cards to end users.

### Sponsor Program Compliance Workflow Module

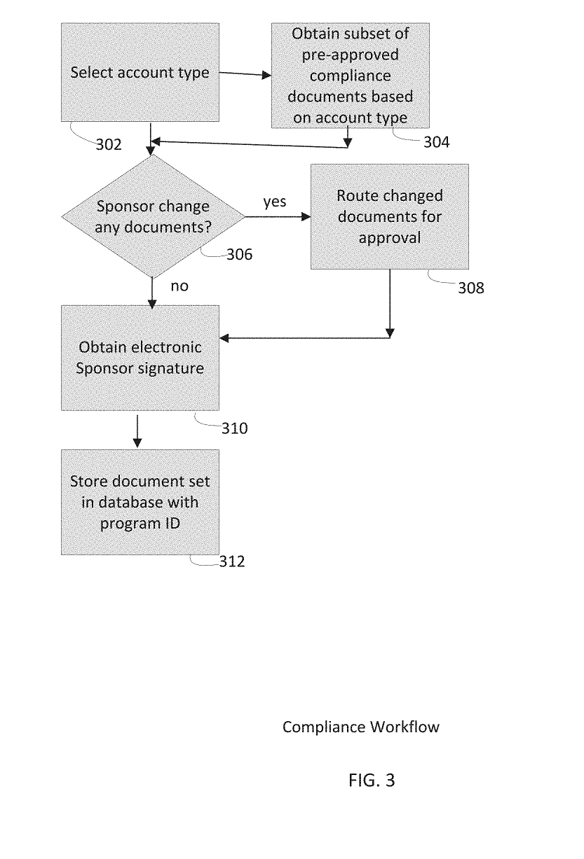

Once a sponsor's identity has been verified, an automated regulatory compliance workflow is executed, as illustrated in FIG. 3. The type and level of compliance needed is determined by the account type selected (302). For example, a gift card requires much less compliance approval than a GPR card, which can require nearly 70 documents be approved. Based on the type of account, a subset of pre-approved documents are retrieved (304) from document database 126. Other information can dictate which documents are required. For example, a high maximum velocity for a gift card can require the same documents as a GPR card.

If a sponsor elects to change any of the documents (306), other than filling in information requested, information is retrieved from the document database on the range of time required for regulatory approval. That amount of time is modified depending on the number of documents elected to be changed. A message is displayed on the GUI for the sponsor informing the sponsor of the delay entailed, and asking for confirmation that the sponsor desires to proceed. If the sponsor desires to proceed, the documents are routed to the appropriate regulatory agencies for review and approval (308). In one embodiment, changes from the pre-approved documents are marked to expedite the review process. The routing is accomplished by invoking a URL with a submission form, or an API, for each relevant regulatory agency. The hub program manager ID and other information is auto-populated, along with the new program ID and sponsor information as required. The changed documents are uploaded.

Upon receiving approvals, any changes are presented to the sponsor for acceptance, or for another round of approval if the sponsor desires further changes. The sponsor is then prompted for electronic signatures on the documents as required (310). The signed documents, along with the approval messages, are then stored in a database, associated with the program ID (312), for later audit purposes.

For a merchant, the number of documents and the approval process may vary depending on the merchant category. For example, merchants in the massage or gambling business will be subject to greater scrutiny.

### URL Placement

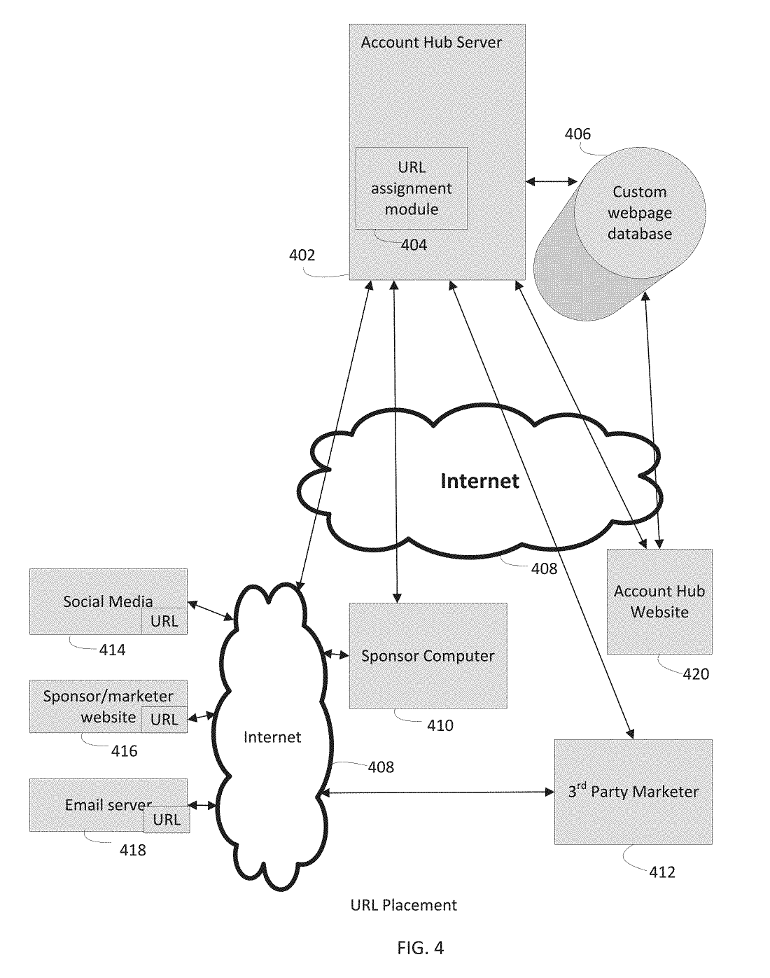

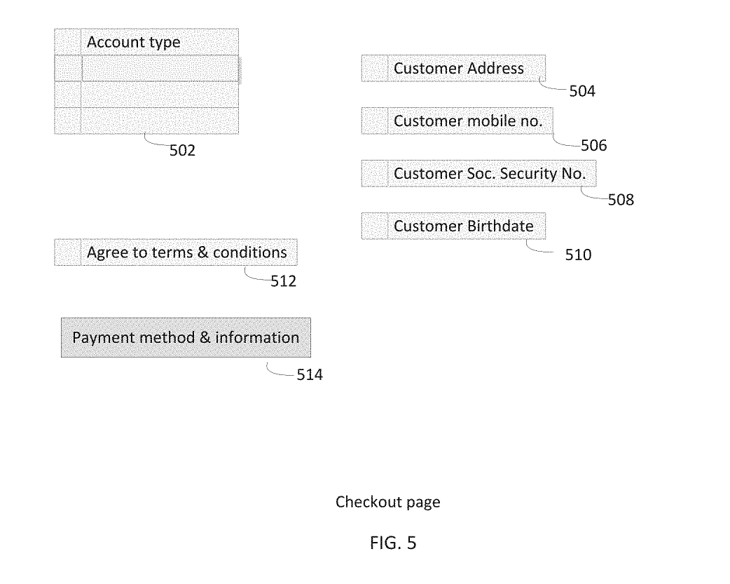

FIG. 4 is a diagram of a URL placement system according to an embodiment. In some embodiments, a URL corresponding to the account program ID is generated by a URL assignment module 404 on account hub server 402 and provided over the internet 408 to the sponsor computer 410. The URL provides a link to a custom account opening webpage maintained by the account hub server in a custom webpage database 406. The custom webpage has a simple checkout mechanism for obtaining an account, as shown in FIG. 5. The URL points to the particular custom webpage.

The URL can be posted in a variety of places, such as on social media 414, on the sponsor's own website 416, or can be provided to an email or text message server 418 to push out to a list of customers or other mailing list. The sponsor is given an option to tag the program as available to 3^{rd} party marketers. The URL can then be provided to a 3^{rd} party marketer 412, which can display them, like the sponsor, on social media 414, on the marketer's own website 416, or can be provided to an email or text message server 418. Each 3^{rd} party marketer is assigned an ID tag that goes along with the URL, so that when the end user clicks on the URL, the marketer tag will be sent to the account hub server and/or sponsor for attribution to the 3^{rd} party marketer.

### Checkout Page

FIG. 5 is a diagram of a checkout page for opening an account according to an embodiment. A standard, simple user experience is provided. The user selects an account type from a dropdown list 502, or alternately from categorized images of cards. The use then inputs a customer address 504, a mobile number 506, a social security number 508 and a birthdate 510. The customer can then view and click to agree to the terms and conditions (512). The user then enters payment information to load the account into a form 514, such as a credit card number.

### Customer Verification

The custom webpage collects information about the type of account selected to be opened, and information about the user. A user identity/compliance module automatically performs appropriate background checking of the user depending upon the type of account. For a gift card, no checking may be needed, simply a valid payment instrument for loading the card/account, and verification that the address, etc. matches the card owner. For a GPR card, for example, an OFAC (Office of Foreign Assets Control) list can be checked. In additional, historical data about the user can be checked for fraud indications. The user information can be cross-referenced with other data by a fraud checking service. The account hub server can maintain its own database of transactions, which can track users and data aggregated across multiple sponsors, giving sponsors more security than with the sponsor's own data.

Customer usage, Tracking Offers

The end users can use the cards or accounts in physical stores or online just like other cards and accounts. Referring back to FIG. 1, a merchant 128 receives a card 130 and processes it through payment network 118. Based on the BIN, the transaction can be routed to sponsor bank 124 or the account hub bank 122. The merchant can be either a physical store or an online merchant. The card can be another account or instrument. Payment processor 120 handles the routing. A record of each transaction can be recorded in a transaction database 132. The database can be associated with the payment processor or the account hub server. Examination of the transaction database allows the account hub server to indicate to sponsors how much a card is used.

### Partner Portal

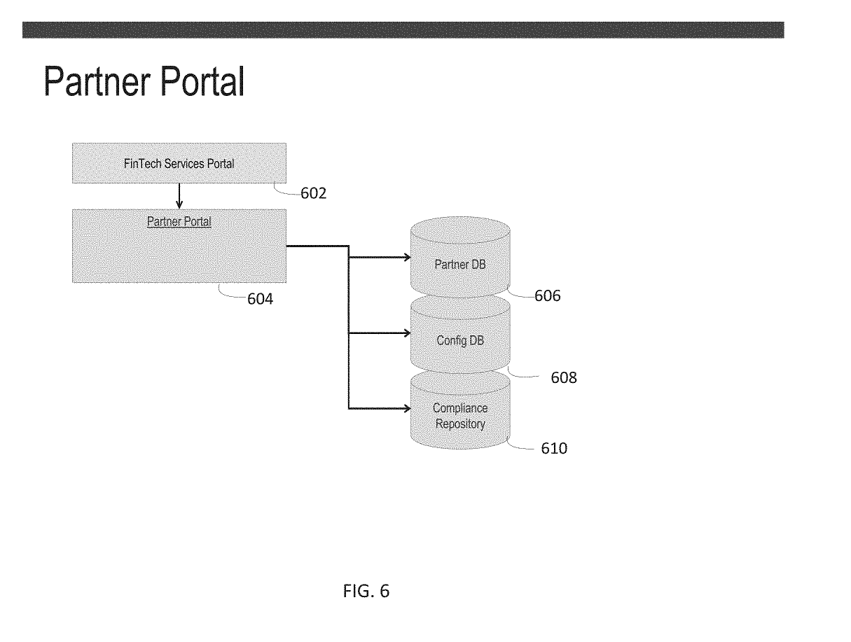

FIG. 6 is a diagram of a partner portal according to an embodiment. A partner portal 604 provides access to the account hub for sponsors and other partners. That access can be through a separate FinTech services portal 602. The partner portal maintains a partner database 606 which stores information on partners, such as hub ID, BIN number, programs IDs, compliance audit trail, etc. A configuration database 608 stores the configuration of the various individual account programs. A compliance repository 610 stores the compliance documents and workflow.

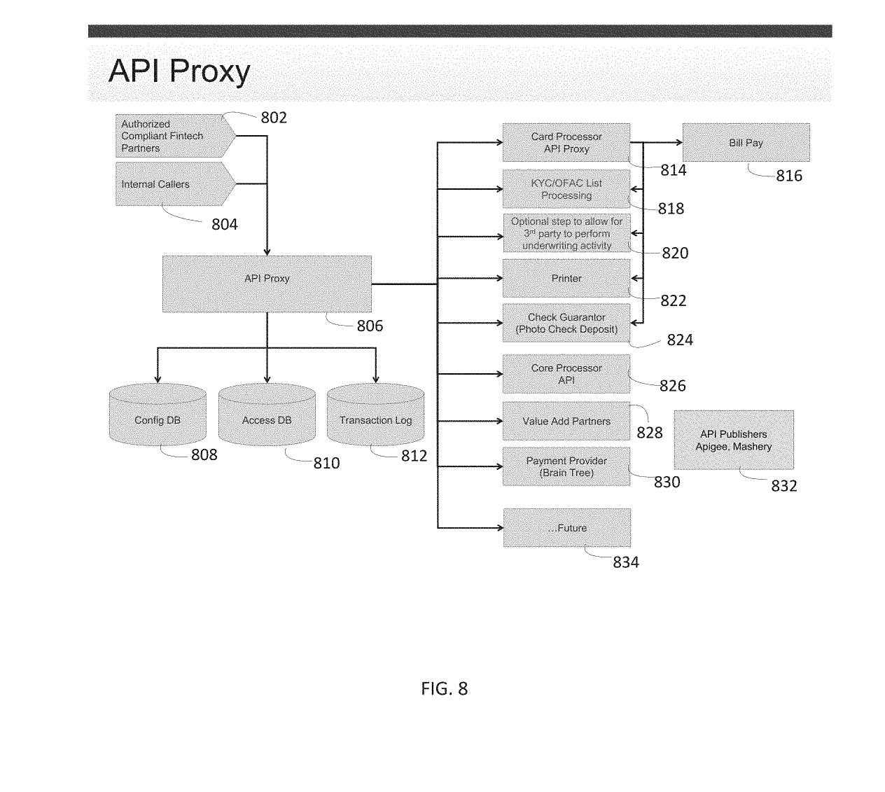

The partners can use the partner portal for a variety of functions. Candidate partners can review available services and requirements. Candidates can apply to become a Program Manager or Card Marketer (Prepaid, Credit). Accounting can be performed as needed. The partner database 606 can store details of each partner, along with reports (from billing, logging extract, etc.). In addition, it can contain a link to a “Compliance Binder” showing the compliance documents and approvals, and updated as needed. The configuration database 608 is an operational database used by the API Proxy (FIG. 8) and a customer account service. Compliance repository 610 contains original compliance templates, compliance workflow rules and pre-approved compliance documents.

### Customer Account Portal

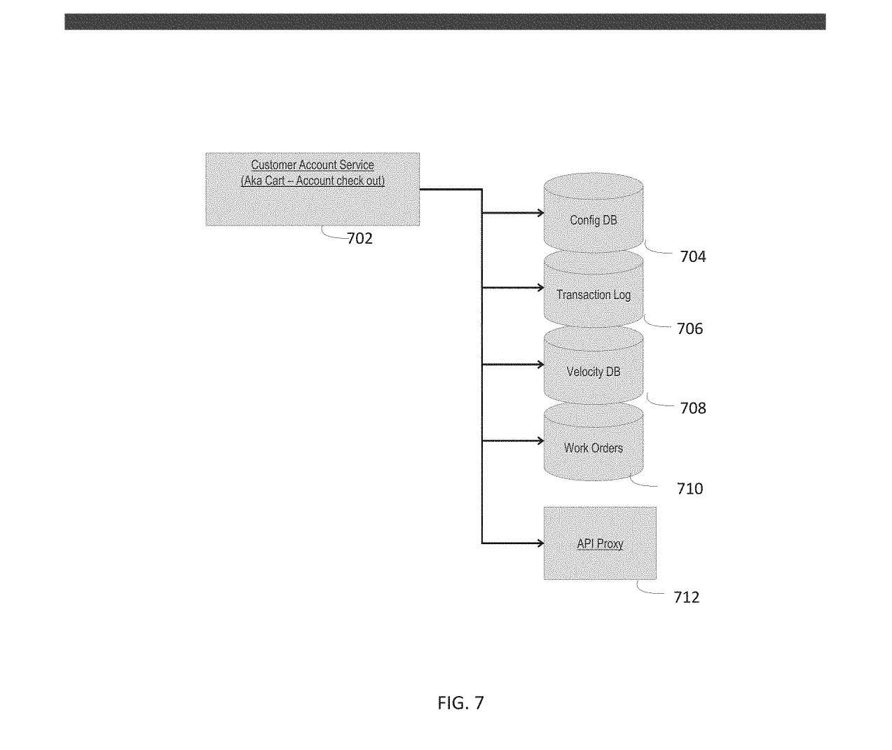

FIG. 7 is a diagram of a customer account portal according to an embodiment. A customer account checkout cart 702 links to a variety of databases. A configuration database 704 provides the data for configuring the checkout cart and account programs. A transaction log database 706 records details of transactions by the end users with the account or card. A velocity database monitors how often money is withdrawn, or the number of gift cards in a time period. A customer account(s) can be flagged, frozen or otherwise dealt with if a maximum is exceeded. A work order database 710 stores requests. Instead of submitting a request via a published API, that the request could be submitted via a delimited file (e.g., an Excel worksheet). This worksheet would get stored and, depending upon the receiving entity (processor), either Account Hub would translate a row in the spreadsheet to an acceptable API format or the receiving entity can accept a spreadsheet as input. API proxy 712 links to the system shown in FIG. 8. The customer account portal can be used by customers to request Gift, Reward or GPR cards, request Credit from a bank/partner, request a debit account, request a loan, request a core account for checking or saving, activate a card, select a card through a referral, etc.

### API Proxy

FIG. 8 is a diagram of an API proxy system according to an embodiment. An API proxy 806 is the website link pointed to by the URLs shown in FIG. 4. The API proxy can be access by authorized, compliant partners (802) and internal callers (804). The internal callers are approved parties and entities (e.g. a new FinTech startup that has been approved to pass data (via the API) to the hub). While the API's may be published (available for one and all to see) only entities that have been approved will be accepted. A configuration database 808 stores the data for configuring the webpage(s). An access database 810 has the data used to validate a user. Transaction log database 812 keeps a record of program transactions.

The API proxy 806 is linked to a variety of other modules. A card processor 814 processes transactions, and can link with a bill pay module 816. A compliance processing module 818 compares users to an OFAC list and/or a KYC (Know Your Customer) compliance data. An optional underwriting module 820 allows a 3^{rd} party to perform underwriting. A printer 822 can print physical plastic gift or other cards. A check guarantor module 824 allows processing of check photos. A core processor 826 is the system (other than a card) that manages other banking services. For example, the managed services could be deposit products, loan Products etc. A module 828 links to valued added partner services, such as a loyalty platform (e.g., points bank), a check printing services (for DDA), etc. A payment provider module 830 enables the acceptance of online and mobile payments. 3^{rd} parties can be enlisted to publish APIs through a publishing module 832. Future expansion is provided for with configurable module 834.

### Computer Diagram

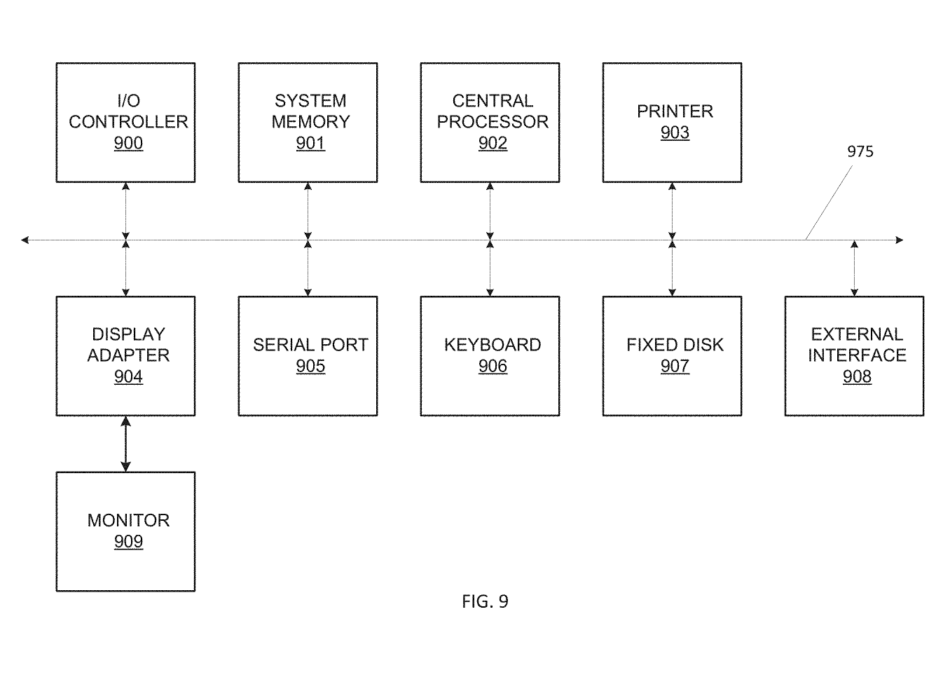

FIG. 9 is a high level block diagram of a computer system that may be used to implement any of the entities or components described above. The subsystems shown in FIG. 9 are interconnected via a system bus 975. Additional subsystems include a printer 903, keyboard 906, fixed disk 907, and monitor 909, which is coupled to display adapter 904. Peripherals and input/output (I/O) devices, which couple to I/O controller 900, can be connected to the computer system by any number of means known in the art, such as a serial port. For example, serial port 905 or external interface 908 can be used to connect the computer apparatus to a wide area network such as the Internet, a mouse input device, or a scanner. The interconnection via system bus 975 allows the central processor 902 to communicate with each subsystem and to control the execution of instructions from system memory 901 or the fixed disk 907, as well as the exchange of information between subsystems. The system memory 901 and/or the fixed disk may embody a computer-readable non-transitory medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

What is claimed is:

1. A filtering and verification hub system comprising:
an interface with a sponsor;
a filtering module configured to automatically determine a level of identity verification depending on the sponsor and a type of arrangement desired to be sponsored;
an identity module configured to verify an identity of the sponsor;
a workflow module for providing an automated workflow; and
an arrangement program ID generation module.

2. The system of claim 1 further comprising a compliance module in communication with the filtering module to further automatically determine a level of regulatory compliance depending on the sponsor and the type of arrangement desired to be sponsored.

3. The system of claim 1 further comprising a document database for storing the arrangement program ID, wherein the arrangement program ID is stored using one of one of AES (128 bits and higher), TDES/TDEA (triple-length keys), RSA (2048 bits and higher), ECC (224 bits and higher), and DSA/D-H (2048/224 bits and higher) encryption.

4. The system of claim 1 further comprising:
an Internet interface for connecting with a sponsor computer, and a user computer, wherein the arrangement is between the sponsor and a user of the user computer.

5. The system of claim 1 further comprising:
a data interchange network; and
an interface for communicating over the data interchange network with an owner system, a sponsor system, and an arrangement processor.

6. The system of claim 1 further comprising a sponsor ID assigned to the sponsor, the sponsor ID being a routing ID used to route to a sponsor system over a data interchange network.

7. The system of claim 1 further comprising:
a compliance module in communication with the filtering module to further automatically determine a level of regulatory compliance depending on the sponsor and the type of arrangement desired to be sponsored; and
a document database storing a plurality of pre-approved compliance documents;
wherein the compliance module is configured to obtain from the document database a subset of the pre-approved compliance documents, the subset being based on the arrangement type.

8. The system of claim 7 wherein the compliance module is further configured to access a sponsor register database.

9. The system of claim 8 wherein the compliance module further includes a signature module for obtaining a signature corresponding to the sponsor.

10. The system of claim 1 further comprising:
a URL generator for generating a URL corresponding to the arrangement program ID, wherein the URL is provided to the sponsor and provides a link to a custom opening webpage maintained under control of the filtering and verification hub server.

11. A filtering and verification hub system comprising:
an interface with a sponsor;
a filtering module configured to automatically determine a level of identity verification depending on the sponsor and a type of arrangement desired to be sponsored;
an identity module configured to verify an identity of the sponsor;
a workflow module for providing an automated workflow;
an arrangement program ID generation module;
a compliance module in communication with the filtering module to further automatically determine a level of regulatory compliance depending on the sponsor and the type of arrangement desired to be sponsored;
a document database storing a plurality of pre-approved compliance documents;
wherein the compliance module is configured to obtain from the document database a subset of the pre-approved compliance documents, the subset being based on the arrangement type;
wherein the compliance module is further configured to access a sponsor register database, a sponsor ID being assigned to the sponsor, the sponsor ID being a routing ID used to route to a sponsor system;
an Internet interface for connecting with a sponsor computer, and a user computer, wherein the arrangement is between the sponsor and a user of the user computer;
a data interchange network; and
an interface for communicating over the data interchange network with a sponsor system using the sponsor ID.

12. A filtering and verification method comprising:
communicating with a sponsor;
automatically determining a level of identity verification depending on the sponsor and a type of arrangement desired to be sponsored;
verifying an identity of the sponsor;
providing an automated workflow; and
generating an arrangement program ID.

13. The method of claim 12 further comprising communicating by a compliance module with a filtering module to further automatically determine a level of regulatory compliance depending on the sponsor and the type of arrangement desired to be sponsored.

14. The method of claim 12 further comprising:
connecting with a sponsor computer, and a user computer, wherein the arrangement is between the sponsor and a user of the user computer.

15. The method of claim 12 further comprising:
providing a data interchange network; and
communicating over the data interchange network with an owner system, a sponsor system, and an arrangement processor.

16. The method of claim 12 further comprising assigning a sponsor ID to the sponsor, the sponsor ID being a routing ID used to route to a sponsor system over a data interchange network.

17. The method of claim 12 further comprising:
communicating with a filtering module to further automatically determine a level of regulatory compliance depending on the sponsor and the type of arrangement desired to be sponsored;
storing a plurality of pre-approved compliance documents in a document database; and
obtaining from the document database a subset of the pre-approved compliance documents, the subset being based on the arrangement type.

18. The method of claim 17 further comprising:
accessing a sponsor register database.

19. The method of claim 18 further comprising:
obtaining a signature corresponding to the sponsor.

20. The method of claim 12 further comprising:
generating a URL corresponding to the arrangement program ID;
providing the URL to the sponsor; and
providing a link to a custom opening webpage.
